(19) United States
(12) Patent Application Publication
(10) Pub. No.: US 2025/0297681 A1
(43) Pub. Date: Sep. 25, 2025

(54) PRESSURE BREAKER WITH COMPOSITE RING

(71) Applicant: Dover Pumps & Process Solutions Segment, Inc., Downers Grove, IL (US)

(72) Inventors: Jason Craig Martin, Louisville, KY (US); Jie Zhou, Pearland, TX (US)

(21) Appl. No.: 19/084,373

(22) Filed: Mar. 19, 2025

Related U.S. Application Data
(60) Provisional application No. 63/567,298, filed on Mar. 19, 2024.

(51) Int. Cl. F16J 15/26; F16J 15/56

(52) U.S. Cl. CPC F16J 15/26; F16J 15/56

(57) ABSTRACT

A packing case for a gas compressor includes two or more progressive seals and a pressure breaker. At least one of the two or more progressive seals includes one or more seal rings at least partially disposed in the packing cup, and one or backup rings at least partially disposed in the packing cup on the driver-side of the one or more seal rings and configured to inhibit extrusion of at least one of the seal rings. The pressure breaker includes one or more composite rings. At least one of the composite rings includes an inner region including a polymeric material and configured to contact a surface of a piston rod of the gas compressor, and an outer region around the inner region and including a metal.

### CROSS-REFERENCE TO RELATED APPLICATION

This application claims the benefit of U.S. Provisional Application No. 63/567,298, filed Mar. 19, 2024, the disclosure of which is incorporated herein by reference in its entirety.

### TECHNICAL FIELD

This invention relates to sealing shafts of high-pressure gas processing equipment such as reciprocating compressors, particularly with progressive sealing systems.

### BACKGROUND

Progressive or multistage sealing systems are commonly employed when high differential pressures are to be maintained, such as between atmosphere and a high-pressure cavity into which a moving shaft extends. Effective, reliable sealing often requires a sealing system in which pressure is reduced along the shaft in stages, or progressively along a labyrinth. The compression industry strives to increase maximum allowable working pressure and system speed as required by heightened customer specifications. However, increasing differential pressure typically makes it more difficult to contain gas within the system and can also apply more stress on associated sealing elements, thereby increasing pressure pulsation within the system, consumption of lubrication oil, and undesired emission of gas to the atmosphere. The pressures encountered in operation result in wear on the seals and reduced reliability.

Packing cases for reciprocating compressors operate with a series of rod rings in individual housings. The compressor stroke of a reciprocating compressor is a dynamic event that occurs in a very short timeframe (e.g., 20 times per second for a 1200 RPM compressor).

The useful life of seal components of a progressive sealing system such as a packing case vary depending on load conditions, seal material properties, environmental conditions, and other factors.

### SUMMARY

Implementations described herein may have particular utility in the context of packing cases for gas processing systems such as reciprocating compressors.

In a general aspect of the disclosure, a packing case for a gas compressor includes two or more progressive seals and a pressure breaker. At least one of the two or more progressive seals includes one or more seal rings at least partially disposed in the packing cup, and one or backup rings at least partially disposed in the packing cup on the driver-side of the one or more seal rings and configured to inhibit extrusion of at least one of the seal rings. The pressure breaker is disposed about the piston rod on the cylinder-side of the two or more progressive seals. The pressure breaker includes one or more composite rings. At least one of the composite rings includes an inner region including a polymeric material and configured to contact a surface of a piston rod of the gas compressor, and an outer region around the inner region and including a metal.

In a general aspect of the disclosure, a pressure breaker configured to receive a piston rod includes one or more rings each defining a bore surface and one or more side surfaces, and a non-metallic coating disposed on a surface of at least one of the one or more rings.

In some implementations, at least one of the rings includes a metal.

In some implementations, the non-metallic coating is disposed on at least a portion of the bore surface of at least one of the one or more rings.

In some implementations, the non-metallic coating is disposed on at least a portion of at least one of at least one of the one or more side surfaces of at least one of the one or more rings.

In some implementations, the non-metallic coating is disposed on at least a portion of the bore surface and at least a portion of at least one of the one or more side surfaces.

In some implementations, the non-metallic coating includes a polymer.

In some implementations, the non-metallic coating includes polyether ether ketone, polytetrafluoroethylene, nylon, or an aromatic thermosetting polyester.

In some implementations, the non-metallic coating includes a diamond-like carbon material.

In some implementations, the non-metallic coating includes a ceramic material. In some implementations, at least one of the one or more rings includes cast iron, bronze, aluminum, an aluminum alloy, or steel.

In some implementations, at least one of the rings includes two or more segments each including a pair of opposing ends, the ends of each pair of the adjacent segments defining a joint between the segments.

In some implementations, the one or more rings include two or more rings.

In some implementations, the non-metallic coating is disposed on the bore surface of each of at least two of the two or more rings.

In some implementations, the one or more rings include two or more rings, further including a non-metallic coating on a side surface of at least one of the rings that contacts a side surface of at least one other of the two or more rings.

In a general aspect of the disclosure, a pressure breaker configured to receive a piston rod includes one or more rings each defining a bore surface and one or more side surfaces, and a coating disposed on the bore surface of at least one of the one or more rings.

In some implementations, the coating includes a polymer.

In some implementations, the coating includes a metal.

In some implementations, the coating is disposed on at least a portion of one or more side surfaces of at least one of the rings.

Particular implementations of the subject matter described in this specification can be implemented so as to realize one or more of the following advantages.

Implementations of the present disclosure may promote longer run life of a compressor system and its components.

Implementations of the present disclosure may reduce the need for lubrication of the piston rod.

Implementations of the present disclosure may reduce wear in seal rings.

Implementations of the present disclosure may reduce deformation of seal rings.

Implementations of the present disclosure may improve rigidity of a packing ring set.

Implementations of the present disclosure may increase the rate of heat transfer from the surface of a piston rod to packing cups.

Implementations of the present disclosure may reduce the risk of scoring or wear on a piston rod surface.

The details of one or more implementations of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 schematically represents a single stage gas processing system with a multistage sealing system.

FIG. 2 is a perspective view of a portion of a reciprocating compressor.

FIG. 3 is an end view of the compressor portion of a gas processing system.

FIGS. 4 and 5 are cross-sectional views showing the shaft at opposite ends of its stroke.

FIG. 6 is an exploded view of the compressor portion of FIG. 3.

FIG. 7 is a cross-sectional view illustrating a packing case including composite backup rings according to some implementations.

FIG. 8 is a cross-sectional view of the packing ring set in a packing cup.

FIG. 9 shows a stack of packing rings from cylinder-side to crank-side.

FIGS. 10 and 11 are a front view and side cross-sectional side view, respectively, of a composite ring having an inner region and an outer region according to some implementations.

FIGS. 12 and 13 are a front view and side cross-sectional side view, respectively, of a composite ring having an inner region and a side region according to some implementations.

FIG. 14 illustrates a seal having a composite backup ring with a side region that contacts the surface of a split seal ring.

FIG. 15 illustrates a composite backup ring having non-metallic side regions on both the front and back sides of the ring.

FIGS. 16 and 17 illustrate a pressure breaker including a composite backup ring according to some implementations.

### DETAILED DESCRIPTION

In various implementations, a gas processing system includes a system that include progressive seal systems. In some implementations, the seals in a progressive seal system include composite backup rings. In some implementations, a pressure breaker includes one or more composite rings.

For explanatory purposes, when describing the relative position of components or features of a system, “driver-side” may also be referred to herein as “crank-side” or “outside”. “Cylinder-side” may also be referred to as “head-side”.

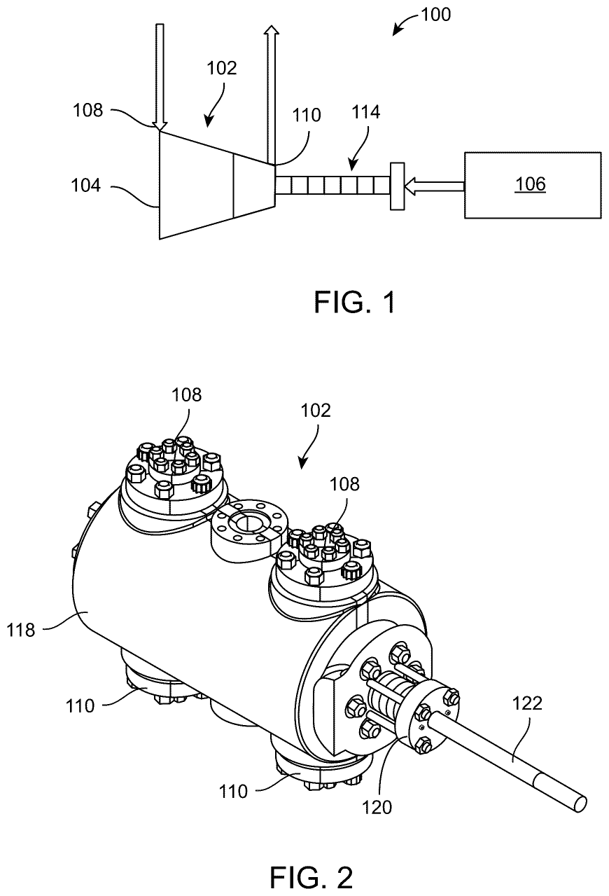

FIG. 1 schematically represents a single stage gas processing system with a multistage sealing system. Gas processing system 100 includes a compressor 102 having a vessel 104 and a driver 106. Vessel 104 defines a cavity with a process gas inlet 108 and a process gas outlet 110. Compressor 102 can be, for example, a positive displacement compressor. In some cases, compressor 102 is a reciprocating compressor, such as a double acting compressor. Vessel 104, configured to contain process gas, is operatively coupled to a shaft that extends into the compressor. A multistage sealing system 114, represented here by a series of boxes along the shaft, inhibits process gas leakage along the shaft. In some implementations, adjacent seals are adjacent portions of a continuous labyrinth seal. The shaft transfers mechanical energy to process gas in vessel 104 (e.g., by or translating along its longitudinal axis), and extends through multistage sealing system 114 into the cavity.

Driver 106 supplies mechanical energy to operate gas processing system 100. In some embodiments, driver 106 may be, for example, an internal combustion engine with a crankshaft, or an electric motor that drives a shaft of compressor 102.

FIG. 2 is a perspective view of a portion of a reciprocating compressor. A cylinder of compressor 102 has a housing 118 and an end plate 120 that bolts to the housing and through which a shaft 122 extends. In some cases, housing 118 is in two pieces, with a cast iron piece forming the main cylinder and a steel bulkhead bolted to the end of the cylinder to contain the sealing system. Compressor 102 can be a linear reciprocating compressor with two inlets 108 and two outlets 110. Shaft 122 can be operatively coupled to a driver.

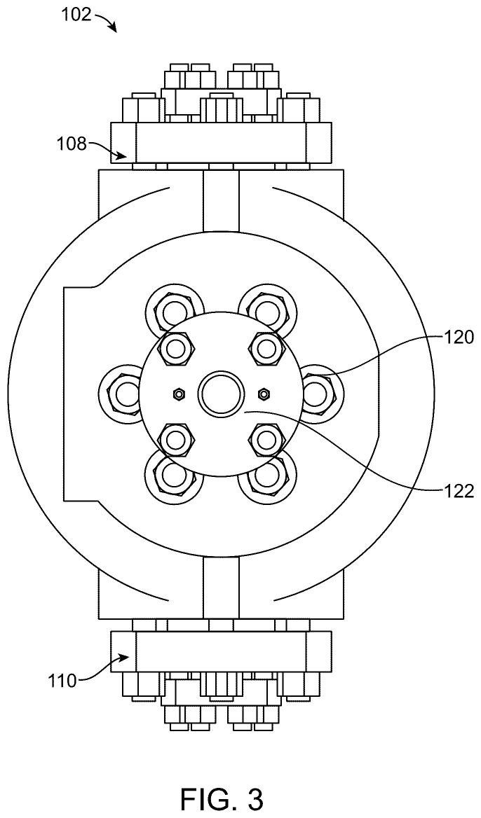

FIG. 3 is an end view of the compressor portion of a gas processing system. Compressor 102 includes end plate 120, inlets 108, and outlets 110. Shaft 122 passes through end plate 120.

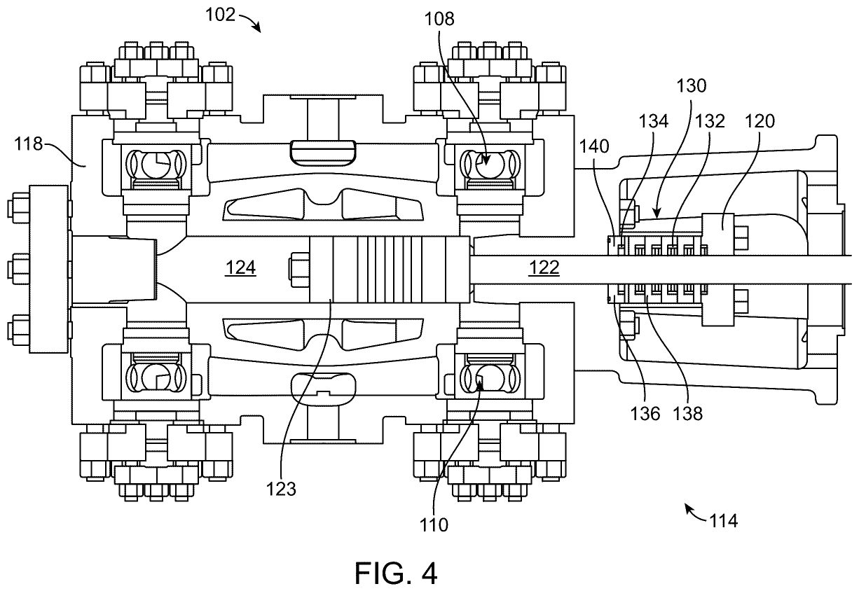

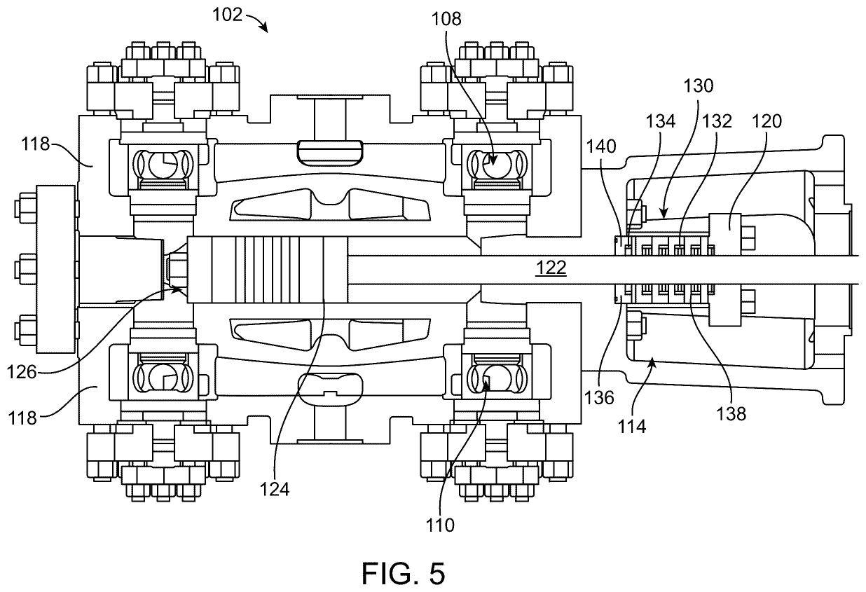

FIGS. 4 and 5 are cross-sectional views showing the shaft at opposite ends of its stroke. piston 124 is provided at the end of shaft 122. Housing 118 defines cylinder chamber 126. The end of shaft 122 that is opposite piston 124 can be coupled to a driver. In operation, piston 124 and a portion of shaft 122 can be driven to reciprocate in cylinder chamber 126, for example, between the positions shown in FIGS. 4 and 5 (the shaft of compressor 102 that carries piston 124 may also be referred to as a “rod”).

Multistage sealing system 114 is disposed about shaft 122. In FIGS. 4 and 5, progressive sealing system 114 is implemented by way of a packing case 130. In this example, multistage sealing system 114 includes seals 132 spaced along the shaft, and a pressure breaker 134. Multistage sealing system 114 can be provided in the form of a packing case for compressor 102. Each seal can include multiple sealing elements or rod rings stacked close together on the shaft, to form a tight series of sealing interfaces with the shaft. In some cases, pressure breaker 134 is a single element seal forming the first seal of the multistage sealing system. In other cases, pressure breaker 134 includes two or more rings. Pressure breaker 134 can control leakage to regulate backflow into the cylinder during the suction stroke and to avoid damaging rings and disengaging them from the rod. Pressure breaker 134 may also reduce gas flow out of the cylinder on the discharge stroke. In certain implementations, pressure breaker 134 can be modified to provide an optimal effective orifice in relation to the flow expected to be returned from behind the rod ring to the inlet, as discussed below. The term “seal” does not imply that there is zero clearance at the shaft surface, or that there is no leakage across the seal. As will be understood by those working in the field of high-pressure gas machinery, some leakage will be expected past high-pressure differential seals, and may even be necessary to avoid high friction and premature seal failure. Expansion of gas between the seals and shaft surface can create a beneficial cooling of the shaft, resulting in lower seal wear.

As shown in these cross-sections, the multistage sealing system comprises pressure breaker housing 136 and multiple seal housings 138 stacked along the shaft and disposed within a bore of housing 118. The innermost seal housing is sealed against a face of the cylinder housing by a nose gasket 140. Each seal housing 138 contains a respective seal 132, with the outermost seal (a dual acting ring) contained within end plate 120. Each of seals 132 can be a stack of multiple elements, such as a seal ring sandwiched between two other rings that support the sealing function.

Compressor cylinder inlets 108 and outlets 110 of gas processing system 100 each feature a one-way valve that allows flow either into (inlet) or out of (outlet) the compressor cylinder, while inhibiting flow in the opposite direction. Each valve can have multiple flow apertures in parallel. The inlets and outlets operate in pairs, each pair operating in a respective stroke direction of the shaft. For example, during the stroke of the piston from right to left there will be an opening of the right inlet 108 and the left outlet 110, at different points during the stroke. Similarly, during the return stroke from left to right there will be an opening of the left inlet 108 and the right outlet 110 and different points during the stroke, while the right inlet and left outlet remain closed. During this return stroke from left to right, the seal end of the cylinder will be subjected to a rise of pressure to at least the outlet pressure of the compressor. This high pressure will be progressively reduced along the shaft through various stages, beginning with pressure breaker 134. During the stroke from right to left, the instantaneous pressure at the pressure breaker will at times be below the compressor inlet or suction pressure, and flow can be in the opposite direction, toward the sealing system. Thus, not only does the sealing system need to withstand high pressures it must also accommodate extreme pressure waves or cycles that may fluctuate very rapidly.

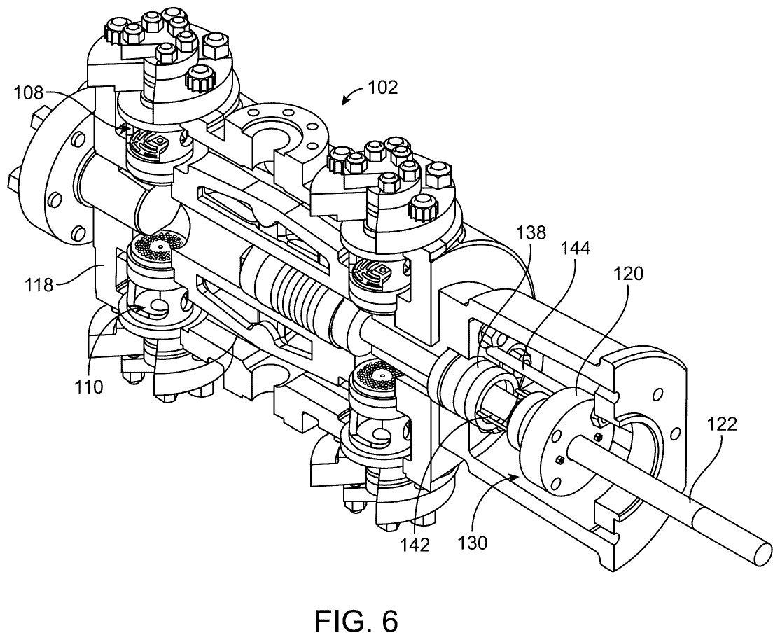

FIG. 6 is an exploded view of the compressor portion of FIG. 3. End plate 120 and its connected stack of seal housings 138, aligned and held together by tie rods 142, is inserted into the bore of compressor housing 118 and held in place by housing bolts 144. The seal housings are all connected axially to end plate 120 by tie rods 142 threaded into the distal seal housing containing the pressure breaker, to hold the stack of seal housings together for transport and assembly. Tie rods 142 can also provide an alignment function.

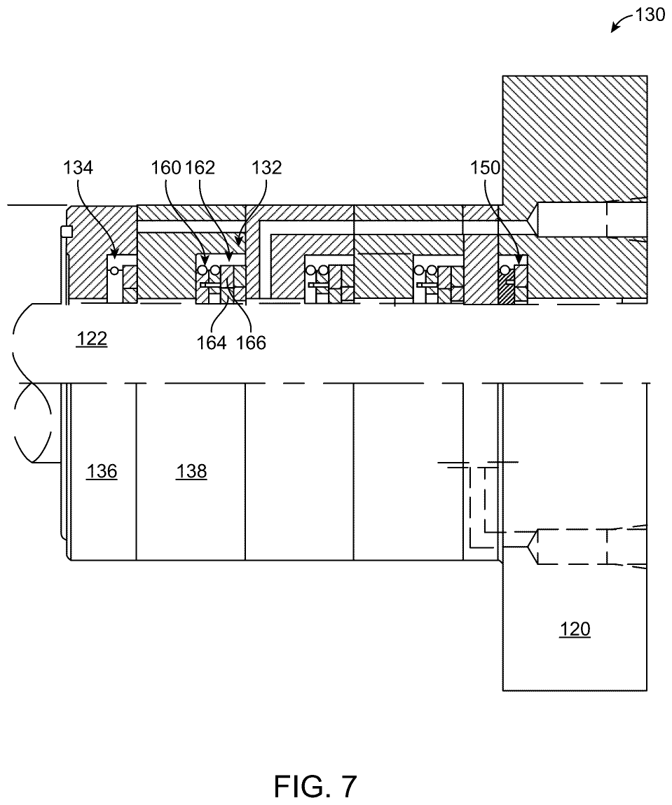

FIG. 7 is a cross-sectional view illustrating a packing case including composite backup rings according to some implementations. Packing case 130 includes seals 132, pressure breaker 134, and end plate seal 150. Each of seals 132 includes seal rings 160 and backup rings 162. Each of backup rings 132 can be a composite ring including two or more regions made of different materials. In the example shown in FIG. 7, each of backup rings 132 includes inner region 164 and outer region 166. Each of inner region 164 and outer region 166 can extend continuously around the circumference of shaft 122.

In the example shown in FIG. 7, each seal 132 includes two seal rings 160. In some implementations, backup rings are compressible to seal on shaft 122.

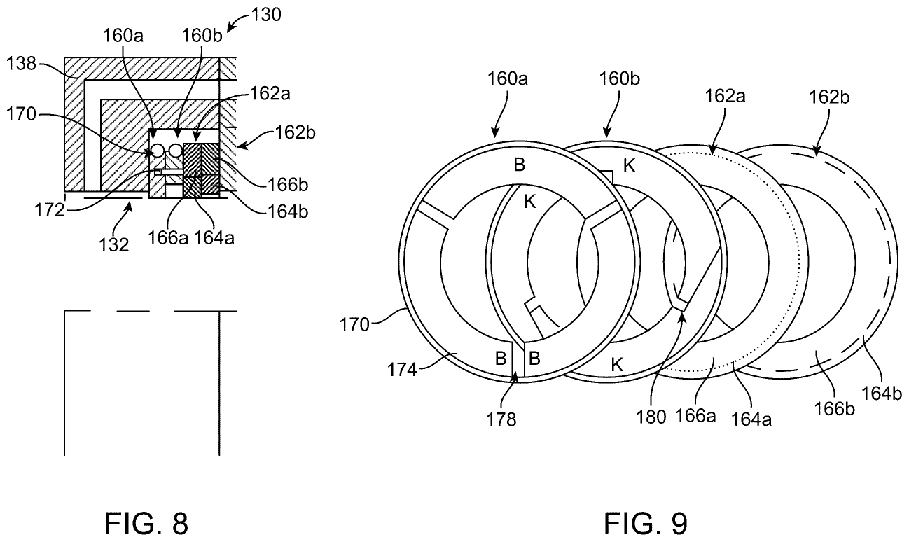

FIGS. 8 and 9 illustrate a set of packing rings including composite backup rings according to some implementations. FIG. 8 is a cross-sectional view of the packing ring set in a packing cup. FIG. 9 shows the stack of rings from cylinder-side to crank-side.

Packing case 130 includes seal 132. Seal 132 includes seal rings 160a and 160b and backup rings 162a and 162b. Each of seal rings 160a and 160b are split rings including multiple segments with joints formed where the ends of the segments meet another. Each segment has an annular shape.

Each of seal rings 160a and 160b includes spring 170. Spring 170 compresses the ring on shaft 122. Anti-rotation device 172 is provided between seal ring 160a and seal ring 160b. Anti-rotation device 172 inhibits relative rotation between seal rings 160a and 160b on shaft 122.

Referring to FIG. 9, each of seal ring 160a and seal ring 160b includes segments 174. Joints 178 are defined where the ends of segments 174 between one another. In the example shown in FIG. 9, seal ring 160a includes radial joints 178 and seal ring 160b includes butt-tangential joints 180. Seal rings can, however, in other implementations, include other types of joints. For example, one or more seal rings of seal ring set can include true tangential joints.

In this example, backup ring 162a and backup ring 162b each have a continuous body. As used herein, continuous includes a ring that does not have elements that move separately with respect to one another. A continuous body can be, for example, an uncut ring. A continuous ring can, however, in some cases, have multiple segments. For example, a continuous ring can have three segments that are bonded to one another (by, for example, an adhesive or weld).

In the example shown in FIGS. 8 and 9, each of backup ring 162a and backup rings 162b is a composite ring. Backup ring 162a includes inner region 164a and outer region 166a. Backup ring 162b includes inner region 164b and outer region 166b. In some implementations, inner regions 164a and 164b include a non-metallic material and outer regions 164a and 164b include a metallic material.

In a specific example, one region (e.g., the inner region) of a ring includes one or more polymer materials such as polyether ether ketone, polytetrafluoroethylene, or aromatic thermosetting copolyester. Another region (e.g., the outer region) includes one or more metal materials such as cast iron, bronze, aluminum, an alloy of aluminum, steel, or alloy. The material of each of the regions of the composite ring can be chosen to impart desired properties to the respective regions, e.g., to impart wear resistance, thermal conductivity, stiffness, mechanical strength, low coefficient of friction, conformability, creep resistance or another property, or a combination thereof.

In one implementation, seal ring 160a and seal ring 160b are compressible on the piston rod at gas pressures less than a predetermined intermediate value. Backup ring 162a is compressible on the piston rod at pressures equal to or greater than the predetermined intermediate value. Backup ring 162b is compressible on the piston rod at pressures equal to or greater than a predetermined high value.

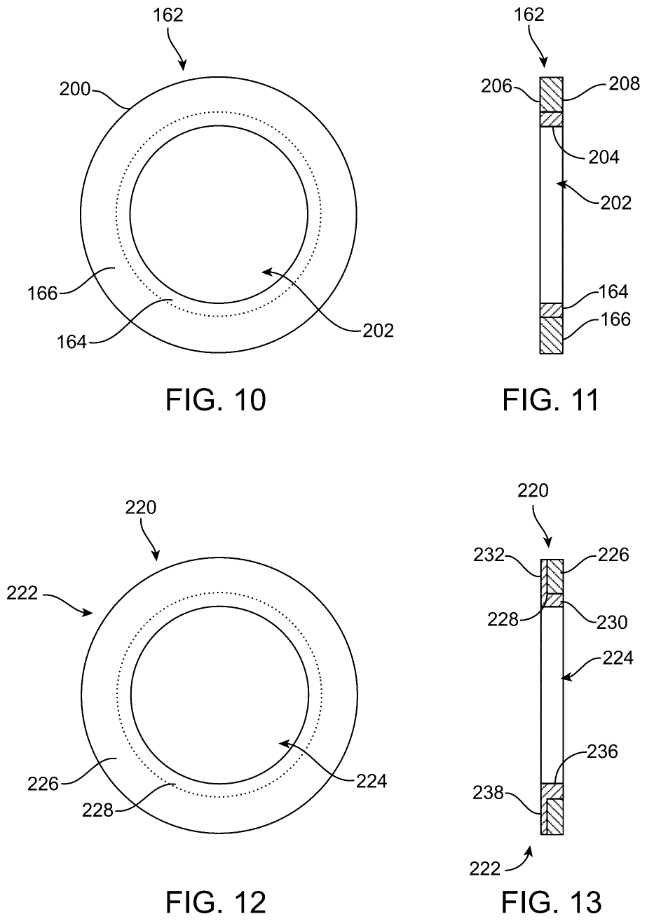

FIGS. 10 and 11 are a front view and side cross-sectional side view, respectively, of a composite ring having an inner region and an outer region according to some implementations. Backup ring 162 includes ring body 200. Ring body 200 defines bore 202. Ring 200 includes inner region 164 and outer region 166. Ring body 200 includes bore surface 204 and side surface 206.

FIGS. 12 and 13 are a front view and side cross-sectional side view, respectively, of a composite ring having an inner region and a side region of a different material than an outer region of the ring according to some implementations. Backup ring 220 includes ring body 222. Ring body 222 defines bore 224. Ring 224 includes first region 226 and second region 228. Second region 228 includes inner region 230 and side region 232. Ring body 222 includes bore surface 236 and side surface 238.

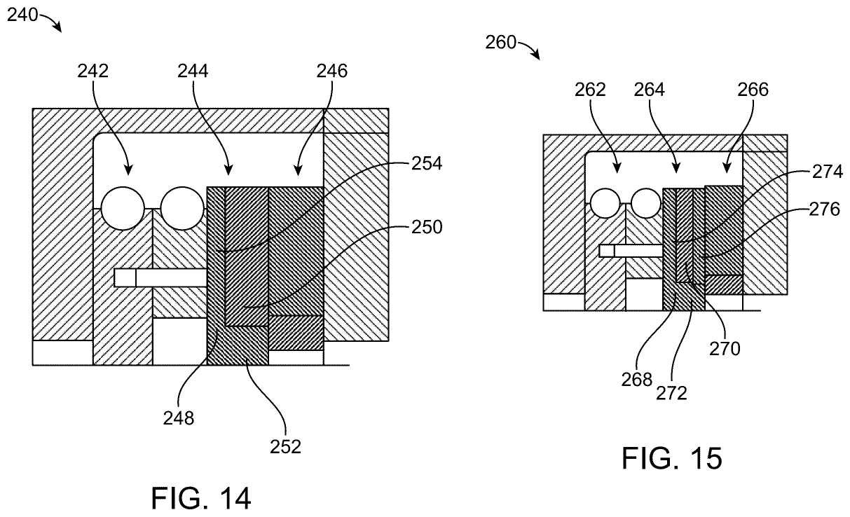

In some implementations, a composite ring includes side regions that contact surfaces of one or more adjoining rings. FIG. 14 illustrates a seal having a composite backup ring with a side region that contacts the surface of a split seal ring. Packing ring set 240 includes seal rings 242, backup ring 244 and backup ring 246. Backup ring 244 includes first region 248 and second region 250. Each of first region 248 and second region 250 can be made of a different material. First region 248 includes inner region 252 and side region 254. In some implementations, first region 248 includes a polymer and second region 250 includes a metal. Side region 254 contacts the driver-side surface of one of seal rings 242.

In some implementations, a composite ring includes side regions on more than one side of the ring. FIG. 15 illustrates a composite backup ring having non-metallic side regions on both the front and back sides of the ring. Packing ring set 260 includes seal rings 262, backup ring 264 and backup ring 266. Backup ring 264 includes first region 268 and second region 270. Each of first region 268 and second region 270 can be made of a different material. First region 268 includes inner region 272, side region 274, and side region 276. In some implementations, first region 268 includes a polymer and second region 270 includes a metal. Side region 274 contacts the driver-side surface of one of seal rings 262. Side region 276 contacts the cylinder-side surface of backup ring 266.

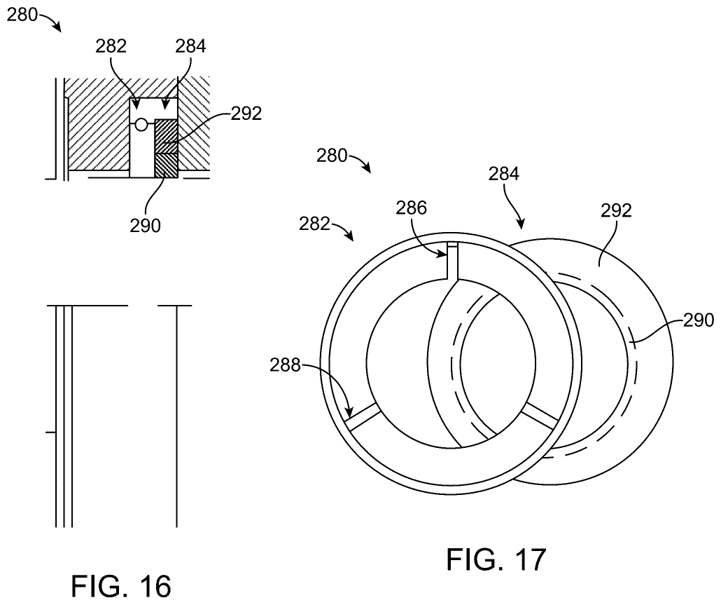

In some implementations, a pressure breaker of a packing case includes a composite ring. FIGS. 16 and 17 illustrate a pressure breaker including a composite backup ring according to some implementations. FIG. 16 is a cross-sectional view of the pressure breaker. FIG. 17 shows the stack of rings of the pressure breaker from cylinder-side to crank-side.

Pressure breaker 280 includes first ring 282 and second ring 284. First ring 282 is the ring of pressure breaker that is closest to the cylinder of the compressor. Second ring 284 is on the driver side of first ring 282. First ring 282 includes cut 286 and notches 288. Cut 286 extends the entire thickness of first ring 282. Notches 288 extend only a portion of the thickness of first ring 282 (e.g., about one-half the thickness of the ring).

Second ring 284 includes inner region 290 and outer region 292. In some implementations, inner region 290 includes a non-metallic material and outer region 292 includes a metallic material. In some implementations, inner region 290 is a polymer coating.

In the example shown in FIGS. 16 and 17, the pressure breaker includes two rings. In other implementations, a composite pressure breaker is in the form of a single composite ring. In still other implementations, a pressure breaker includes three or more rings.

In some implementations, a composite seal includes a base and a coating. For example in illustrated FIGS. 10 and 11, outer region 166 can be a metal ring and inner region 164 can be a coating applied to the metal ring. As another example, in the example illustrated in FIGS. 12 and 13, first region 226 can be a metal ring and second region 228 can be a polymer coating applied to the metal ring. In some implementations, a coating covers the entire outer surface of a base ring. In some implementations, a coating thickness can be from a few micrometers to several millimeters.

In some implementations, the base ring includes a metal, such as bronze. In other implementations, the base ring is a non-metallic ring. The coating for a ring can, in some implementations, include a polymer. Examples of polymers in coatings include polyether ether ketone, polytetrafluoroethylene, or aromatic thermosetting copolyester.

In some implementations, a packing case is selected from a standard list of packing cases based on pressure rating of a class of cylinder. Seal material selections can be assigned for each cylinder class based on the optimal sealing arrangement for each. A activation pressure (e.g., closedown pressure) can be calculated for each backup ring. The activation pressure can be the pressure at which the ring collapses under pressure to seal against the piston rod. The activation pressure can be a function of mechanical properties of each material and geometry of the ring. In some implementations, an optimal selection includes the first backup ring activating at low pressure than a second backup ring activates. Pressures used in the calculation can be the expected operating pressures based on cylinder ratings.

Second ring 284 is a composite ring including inner region 288 and outer region 250. In some implementations, inner region 288 includes a non-metallic material and outer region 250 includes a metallic material. In some implementations, the non-metallic material in an inner region of a ring is a polymer, such as polyether ether ketone, polytetrafluoroethylene, or aromatic thermosetting copolyester.

In various implementations described above, a composite ring is a backup ring. In some implementations, a composite ring is a seal ring of a packing ring set.

In various implementations described above, a composite ring is a continuous ring. In some implementations, segments of a ring are composite elements. For example, each of segments 174 shown in FIG. 7 can include two or more regions each of made of a different material.

As used herein, in the context of a sealing system, “degradation” includes any changes in one or more seals that reduce the effectiveness of the sealing system or move the seal toward the end of its useful life.

As used herein, “chamber” includes an at least partially enclosed space.

As used herein, a “driver” includes a device that supplies mechanical energy to operate a system.

As used herein, a “housing” may completely or only partially enclose the component(s) that it houses.

As used herein, “progressive” refers to a sealing system having multiple sealing members between a high pressure point and a low pressure point. In many cases, such systems progressively reduce the pressure in stages between the high and low pressure points.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A packing case for a gas compressor, the packing case comprising:
two or more progressive seals, at least one of the two or more progressive seals comprising:
one or more seal rings at least partially disposed in the packing cup; and
one or more backup rings at least partially disposed in the packing cup on the driver-side of the one or more seal rings and configured to inhibit extrusion of at least one of the seal rings; and
a pressure breaker disposed about the piston rod on the cylinder-side of the two or more progressive seals, the pressure breaker comprising:
one or more composite rings, at least one of the composite rings comprising:
an inner region comprising a polymeric material and configured to contact a surface of a piston rod of the gas compressor; and
an outer region around the inner region and comprising a metal.

2. A pressure breaker configured to receive a piston rod, the pressure breaker comprising:
one or more rings each defining a bore surface and one or more side surfaces; and
a non-metallic coating disposed on a surface of at least one of the one or more rings.

3. The pressure breaker of claim 2, wherein at least one of the rings comprises a metal.

4. The pressure breaker of claim 2, wherein the non-metallic coating is disposed on at least a portion of the bore surface of at least one of the one or more rings.

5. The pressure breaker of claim 2, wherein the non-metallic coating is disposed on at least a portion of at least one of at least one of the one or more side surfaces of at least one of the one or more rings.

6. The pressure breaker of claim 2, wherein the non-metallic coating is disposed on at least a portion of the bore surface and at least a portion of at least one of the one or more side surfaces.

7. The pressure breaker of claim 2, wherein the non-metallic coating comprises a polymer.

8. The pressure breaker of claim 2, wherein the non-metallic coating comprises polyether ether ketone, polytetrafluoroethylene, nylon, or an aromatic thermosetting polyester.

9. The pressure breaker of claim 2, wherein the non-metallic coating comprises a diamond-like carbon material.

10. The pressure breaker of claim 2, wherein the non-metallic coating comprises a ceramic material.

11. The pressure breaker of claim 2, wherein at least one of the one or more rings comprises cast iron, bronze, aluminum, an aluminum alloy, or steel.

12. The pressure breaker of claim 2, wherein at least one of the rings comprises two or more segments each comprising a pair of opposing ends, the ends of each pair of the adjacent segments defining a joint between the segments.

13. The pressure breaker of claim 2, wherein the one or more rings comprise two or more rings.

14. The pressure breaker of claim 2, wherein the non-metallic coating is disposed on the bore surface of each of at least two of the two or more rings.

15. The pressure breaker of claim 2, wherein the one or more rings comprise two or more rings, further comprising a non-metallic coating on a side surface of at least one of the rings that contacts a side surface of at least one other of the two or more rings.

16. A pressure breaker configured to receive a piston rod, the pressure breaker comprising:
one or more rings each defining a bore surface and one or more side surfaces; and
a coating disposed on the bore surface of at least one of the one or more rings.

17. The pressure breaker of claim 16, wherein the coating comprises a polymer.

18. The pressure breaker of claim 16, wherein the coating comprises a metal.

19. The pressure breaker of claim 16, wherein the coating is disposed on at least a portion of one or more side surfaces of at least one of the rings.
